(19) United States
(12) Patent Application Publication
(10) Pub. No.: US 2006/0184396 A1
(43) Pub. Date: Aug. 17, 2006

(54) System and method for surgical navigation

(76) Inventors: Charles L. Dennis, Lake Elmo, MN (US); James F. Kelley, Coon Rapids, MN (US)

Correspondence Address: MEDTRONIC, INC., 710 MEDTRONIC PARK, MINNEAPOLIS, MN, 55432-9924, US

(21) Appl. No.: 11/045,849

(22) Filed: Jan. 28, 2005

(51) Int. Cl. G06Q 40/00

(52) U.S. Cl. 705/4

(57) ABSTRACT

A surgical intervention data base includes major systems including a navigational system, an interventional system, a billing system and an on-line authorization system. The navigational system includes sub-systems that provide communication between the major systems to enable registration of data sets, image displays and billing capabilities for services rendered. Further, the navigational system distinguishes between registered and non-registered images.

### TECHNICAL FIELD

The present invention relates to surgical navigation, and more particularly to surgical navigation systems that combine multiple sources of information to aid in localization.

### BACKGROUND

Recent advances in minimally invasive surgery utilize anatomical data collected by preoperative scanning techniques, for example magnetic resonance imaging (MRI), computerized tomography (CT), ultrasound, fluoroscopy and positron emission tomography (PET), to facilitate guidance of an interventional device to a precise location by providing a more accurate view of an anatomical context through which the device is navigated. To accomplish this, the anatomical data must be registered with position-indicating data, i.e. that data collected during the intervention, which reflects positions of an interventional tool; some registration methods have been described in U.S. Pat. Nos. 6,235,038 and 6,402,762, which are incorporated by reference herein. Furthermore, U.S. Patent Application 2003/0187358, which is also incorporated by reference herein, describes registration of 3D image data within an interventional system using three anatomical landmarks.

While surgical navigation using registered images is useful, it may not be necessary in all interventional procedures. Simple imaging performed at the time of the intervention without the need for registration of data from multiple sources, or no imaging at all, may be sufficient for some interventional procedures. However, systems and/or software needed to carry out the registration may be integrated components of standard navigational equipment used for all interventional procedures whether or not the registration function is required. For this and other reasons, it would be desirable to incorporate into such equipment means for monitoring use of the registration function.

### SUMMARY

Methods according to embodiments of the present invention comprise the following steps: receiving authorization to use registration capabilities included in a navigation system and registering one or more anatomical data sets stored in the navigation system with one or more position-indicating data sets collected by an interventional system, upon receipt of authorization. Methods according to additional embodiments comprise the step(s) of counting a number of times registration of data sets occurs during an interventional procedure and/or communicating the registration(s) to a billing system.

Systems and configurations according to embodiments of the present invention comprise an authorization tag/device adapted to send a signal to a registration sub-system of the system, which signal enables or disables registration of one or more anatomical data sets with one or more position-indicating data sets. Systems and configurations according to alternate embodiments of the present invention comprise a communications sub-system establishing a communication link between the system and an online authorization system, which sends a signal to either enable or disable a registration sub-system of the system. Systems and configurations according to additional embodiments of the present invention comprise a counter adapted to count a number of times a registration function is used and/or a communications sub-system adapted to communicate the registration(s) to a billing system.

### BRIEF DESCRIPTION OF THE DRAWINGS

FIG. 1 is a flow chart describing methods according to alternate embodiments of the present invention.

FIG. 2 is a block diagram of a surgical system 15 according to an embodiment of the present invention.

### DETAILED DESCRIPTION

The following description is illustrative of particular embodiments of the invention and therefore does not limit its scope, but is presented to assist in providing a proper understanding of the invention. The figures are intended for use in conjunction with the explanations in the following detailed description.

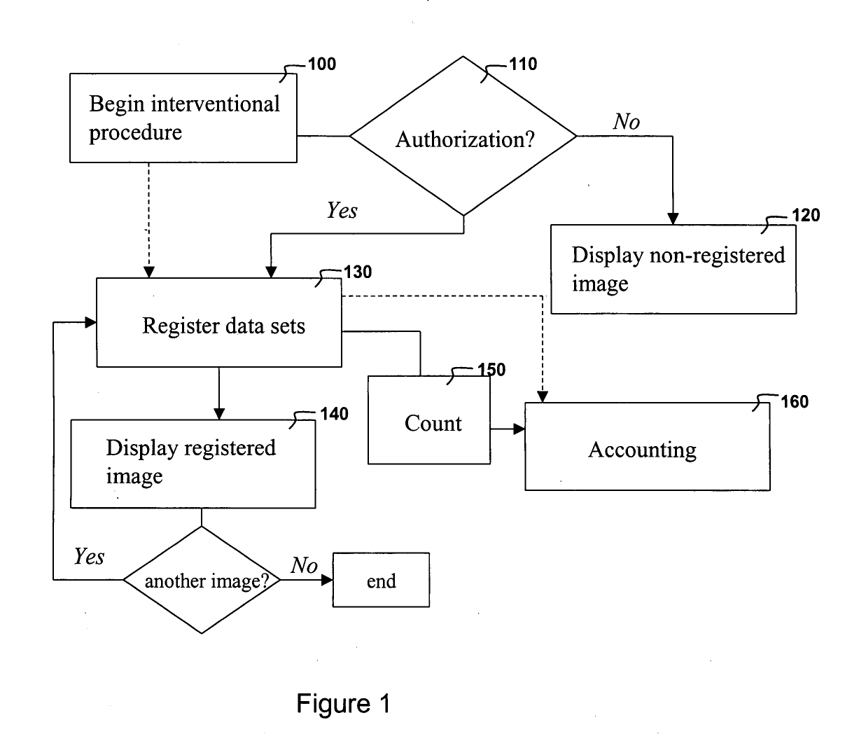

FIG. 1 is a flow chart describing methods according to alternate embodiments of the present invention. FIG. 1 illustrates a first step 100 wherein an interventional procedure is begun; a purpose for such a procedure may be, for example, to implant a therapeutic or diagnostic device, to perform a therapeutic or diagnostic procedure, to gather data sets of navigational landmarks or any combination thereof, and a variety interventional systems and processes associated with each of these purposes are well known to those skilled in the art. Approximately coincident with first step 100 an authorization step 110 takes place in which a navigational system, used in conjunction with the interventional system, receives a signal directing the navigational system to register or not to register one or more anatomical data sets with another one or more position indicating data sets collected during the interventional procedure. The one or more anatomical data sets, according to one embodiment of the present invention, include 3-dimensional anatomical data collected by a scan; examples of such scans include, but are not limited to, MRI, CT, ultrasound, fluoro and PET. Examples of the one or more data sets gathered during the interventional procedure include but are not limited to electrical maps, pressure maps, fluoroscopic images and ultrasound images.

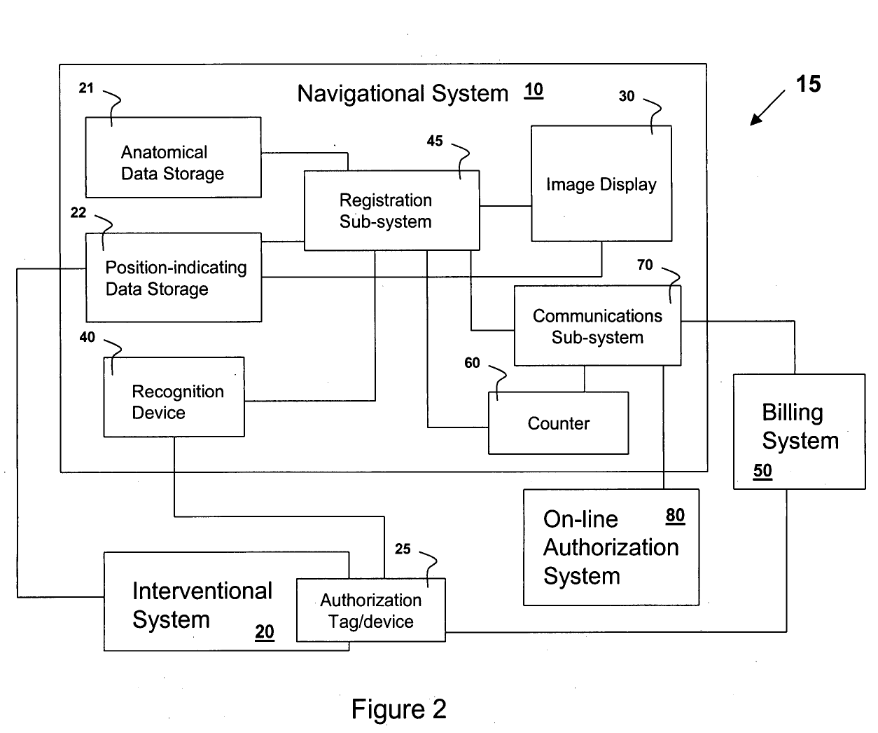

According to one embodiment of the present invention, the authorization signal of step 110 is sent by a tag or device included with the interventional system; according to an alternate embodiment the signal is sent by an online authorization system. Means for sending the authorization signal will be described in greater detail in conjunction with FIG. 2.

If, in authorization step 110, the navigational system receives a signal directing the system to register, a step 130 follows in which the one or more anatomical data sets are registered to the interventional system, that is, the anatomical data is combined with one or more position indicating data sets collected by the interventional system to provide a registered image, step 140; registration methods are known to those skilled in the art and examples of these methods are described in the aforementioned patents and patent application incorporated by reference herein. If the navigation system receives a signal directing the system not to register, the registration function is bypassed and the system simply provides an image or images based upon the one or more data sets collected by the interventional system without registration, step 120.

FIG. 1 further illustrates, approximately coincident with registration step 130, a counting step 150. Under step 150, counts relating to a number of times the registration step occurs in order to monitor the use of the registration function are made. Because a number of different images may be required to assist navigation during the interventional procedure, a number of different registrations may be required to generate multiple registered images. According to the illustrated embodiment, an accounting step 160 receives the count in order to automatically generate a bill for use of the registration function. According to another embodiment, counting step 150 is not included and, alternatively, accounting step 160 flows from registration step 130, i.e. per the dashed line.

It should be noted that embodiments of the present invention include methods, which do not include all of the steps illustrated in FIG. 1. For example, one method according to the present invention includes only steps 100, 110, 120, 130 and 140 (i.e. including an authorization function but not including counting or billing), while another method includes only steps 100, 130, 140, 150 and 160 (i.e. including counting and billing functions but not including authorization).

FIG. 2 is a block diagram of a surgical system 15 according to an embodiment of the present invention. FIG. 2 illustrates system 15 including a navigational system 10, an interventional system 20, a billing system 50 and an online authorization system 80. According to embodiments of the present invention interventional system 20 may be any one of those known to a person skilled in the art, as previously described in conjunction with FIG. 1; examples of interventional systems include but are not limited to those including implantable leads or catheters having means to collect position-indicating data during the interventional procedure, for example electrodes and/or transducers. FIG. 2 further illustrates navigational system 10 including an anatomical data storage subsystem 21, a position-indicating data storage subsystem 22, a registration subsystem 45, and a recognition device 40, which receives a signal from an authorization tag/device 25, included with interventional system 20. According to embodiments of the present invention, the signal either enables or disables registration sub-system 45. In the event registration sub-system 45 is enabled, one or more data sets from anatomical data storage 21 will be combined with one or more data sets from position-indicating data storage 22 within registration subsystem 45, which is adapted to register the data sets and prepare a registered image for an image display monitor 30. Sources of anatomical data were previously described in conjunction with FIG. 1. If registration sub-system 45 is disabled, image display monitor 30 receives an un-registered image including data from storage 22.

Authorization tag/device 25, according to some embodiments of the present invention, is included in a package with one or more components of interventional system 20 and may either be an independent element or an element affixed to one of the components of system 20. According to one embodiment, tag/device 25 is passive such that only its presence in proximity to navigational system is detected by recognition device 40 and this detection enables registration sub-system 45; examples of such tags include but are not limited to a resonant coil and a radio frequency identification (RFID) tag, either of which may be integrated into an implantable pulse generator, a lead or a catheter according to means known to those skilled in the art. Alternatively, tag/device 25 may be programmed to send a signal, for example a passive bar code or an active transponder, to either enable or disable registration sub-system 45 via recognition device 40. According to alternate embodiments tag/device 25 need not be packaged with any components of interventional system 20 and may be associated with other components used in interventional procedures, such as surgical drapes or an adhesive patch.

FIG. 2 further illustrates navigational system 10 including a communications sub-system 70, which can be any form of electronic communication, such as telephone, internet, local network, wireless or the like, linked to registration sub-system 45; according to another embodiment of the present invention, when use of registration sub-system 45 is requested, communications sub-system 70 sends the request to an online authorization system 80, which, rather than tag/device 25, sends an enabling or disabling signal back to communications sub-system 70, which in turn passes the signal to registration sub-system 45. Online authorization system 80 may be anything ranging from a fully automated system to a connection to a person who authorizes the use.

According to another aspect of the present invention, communications sub-system 70 delivers information regarding use of registration sub-system 45 to billing system 50, which uses the information to accrue charges related to use of registration sub-system 45. According to an alternate embodiment, billing system 50 receives information regarding authorization for use of registration sub-system 45 when tag/device 25 is pulled from inventory for-an interventional procedure, thereby accruing a charge related to use of registration sub-system 45.

FIG. 2 further illustrates navigational system 15 including a counter 60 adapted to count a number of times registration sub-system 45 is used in order to monitor use of the registration function; a count provided by counter 60 may be sent via communications sub-system 70 to billing system 50. According to some embodiments, counter 60 includes additional capability to time-stamp each use of registration sub-system 45 and to record information regarding which data sets are registered for each count.

In the foregoing detailed description, the invention has been described with reference to specific embodiments. However, it may be appreciated that various modifications and changes can be made without departing from the scope of the invention.

What is claimed is:

1. A computer-implemented software system operating a surgical intervention data base comprising:
means for receiving authorization to use registration capabilities embedded in the data base;
means for registering at least one anatomical data sets stored in the data base; and
means for displaying at least one registered image;
said means for receiving, said means for registering and said means for displaying being operably coordinated, after receipt of authorization, to access data sets stored in the data base.

2. The data base of claim 1 wherein said means for receiving includes means for displaying non-registered images.

3. The data base of claim 1 wherein said means for registering includes at least one image required for navigation.

4. The data base of claim 1 wherein said means for displaying includes image display element in data communication with position-indicating data storage.

5. The data base of claim 1 wherein said means for displaying includes image display element in data communication with position-indicating data storage and with a registration sub-system.

6. The data base of claim 1 wherein said means for displaying includes image display element in data communication with position-indicating data storage, and a registration sub-system.

7. The data base of claim 1 wherein an interventional system maintains data communication with position-indicating data storage and an authorization tag.

8. The data base of claim 7 wherein said authorization tag maintains data communication with a recognition device and a billing system.

9. A surgical system comprising:
a navigational system;
an interventional system;
a billing system; and
an authorization system;
said navigational, interventional, billing and authorization systems being in operable bi-directional communication to enable image registration, storage, identification and processing during an interventional surgical procedure.

10. The system of claim 9 wherein said navigational system includes a registration sub-system in bidirectional data communication with an anatomical data storage, an image display, a position-indicating data storage, a recognition device, a counter and a communications sub-system.

11. The system of claim 10 wherein said counter includes a data communication route with said communications sub-system.

12. The system of claim 9 wherein said communications system includes a bidirectional data communications route to said billing system and said on-line authorization system.

13. The system of claim 9 wherein said interventional system includes an authorization tag in data communications with said recognition device.

14. The system of claim 13 wherein said interventional system maintains bi-directional data communications with said billing system through an interface of said authorization tag.

15. A method for operation of an interventional procedure comprising:
activating an authorization system;
registering data sets; and
displaying registered images composed from said data sets.

16. The method of claim 15 wherein the activating process includes distinguishing between authorized and unauthorized images.

17. The method of claim 16 wherein said distinguishing between images further includes displaying non-registered images.

18. The method of claim 15 wherein said process of registering data sets includes coincidentally counting said data sets.

19. The method of claim 18 wherein said counting process further includes transmitting the data sets into an accounting data base to process billing.

20. The method of claim 15 wherein said process of registering data sets further includes transmitting data to an accounting data base to process billing.
